(19) United States
(12) Patent Application Publication
(10) Pub. No.: US 2011/0246805 A1
(43) Pub. Date: Oct. 6, 2011

(54) POWER MANAGEMENT UNIT FOR PORTABLE ELECTRONIC DEVICES

(75) Inventor: Chun-Po Chen, Tu-Cheng (TW)

(73) Assignee: HON HAI PRECISION INDUSTRY CO., LTD., Tu-Cheng (TW)

(21) Appl. No.: 12/842,135

(22) Filed: Jul. 23, 2010

(30) Foreign Application Priority Data
Apr. 6, 2010 (TW) 99110557

(51) Int. Cl. G06F 1/28

(52) U.S. Cl. 713/340

(57) ABSTRACT

A power management unit (PMU) for supplying electrical energy to a circuitry of a portable electronic device includes a power supply module, a power detection module connected to the power supply module, and a power control module connected to the power detection module and the circuitry. The power supply module provides electrical energy to the circuitry through the power detection module and the power control module. The power detection module detects the power of the electrical energy provided to the circuitry and controls the power control module to limit the power of the electrical energy provided to the circuitry when the power of the electrical energy provided to the circuitry exceeds a predetermined value.

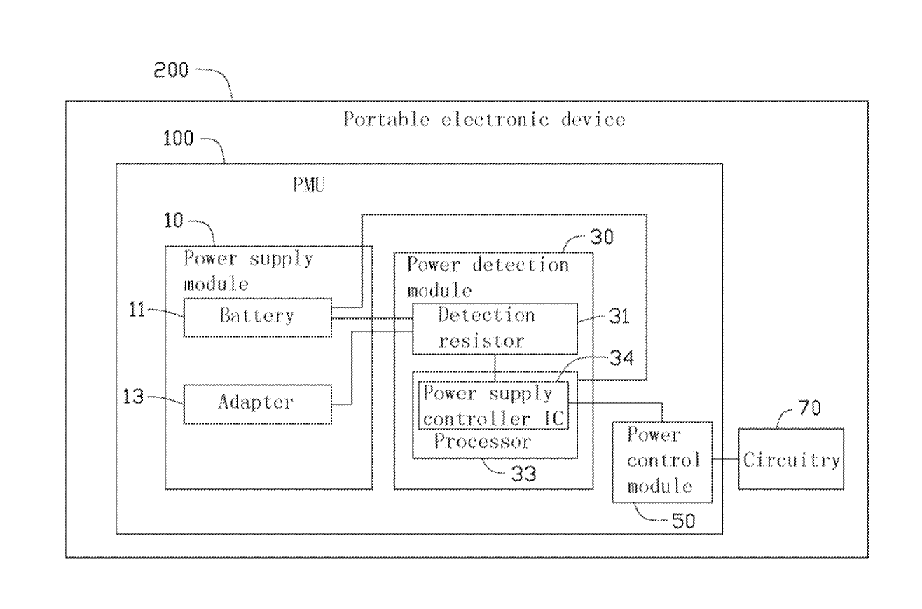

### BACKGROUND

1. Technical Field

The present disclosure relates to power management units (PMU) used in portable electronic devices, and particularly to a PMU capable of protecting portable electronic devices from over-current.

2. Description of Related Art

Portable electronic devices are continuously required to achieve higher quality, for example, higher data processing speeds, display quality, or communication quality. However, when these functions of the portable electronic devices are enhanced, the portable electronic devices generally need to consume more power and use higher working currents. If the working currents are too high, they may damage the portable electronic device, or cause the portable electronic devices to automatically switch themselves off as protection from over-current.

Therefore, there is room for improvement within the art.

### BRIEF DESCRIPTION OF THE DRAWINGS

Many aspects of the present power management unit (PMU) can be better understood with reference to the following drawings. The components in the various drawings are not necessarily drawn to scale, the emphasis instead being placed upon clearly illustrating the principles of the present PMU. Moreover, in the drawings, like reference numerals designate corresponding parts throughout the figures.

The drawing is a block diagram of a portable electronic device using a PMU according to an exemplary embodiment.

### DETAILED DESCRIPTION

The drawing shows a power management unit (PMU) 100, according to an exemplary embodiment. The PMU 100 can be used in a portable electronic device 200, such as a laptop computer or a notebook computer, to supply electrical energy to a circuitry 70 of the portable electronic device 200. The circuitry 70 can include a central processing unit (CPU), a hard disk drive, a display, and other conventional components. The PMU 100 includes a power supply module 10, a power detection module 30, and a power control module 50. The power supply module 10, the power detection module 30, and the power control module 50 are electrically connected in series. The circuitry 70 is electrically connected to the power control module 50 to get electrical energy.

The power supply module 10 includes a battery 11 and an adapter 13, which are both electrically connected to the power detection module 30. The battery 11 is a rechargeable battery for supplying electrical energy to the circuitry 70 through the power detection module 30 and the power control module 50. The adapter 13 can be connected to other power supplies. In use, the adapter 13 can regulate the voltage level of electrical energy provided by another power supply connected thereto to a predetermined value, and provide the electrical energy having a regulated voltage to the circuitry 70 through the power detection module 30 and the power control module 50.

The power detection module 30 includes a detection resistor 31 and a processor 33 electrically connected to the detection resistor 31 and the power control module 50. The battery 11 and the adapter 13 are both electrically connected to the detection resistor 31. The processor 33 includes a power supply controller integrated circuit (IC) 34 integrated therein. The power supply controller IC 34 can be a MAX8724 chip. The processor 33 can detect the current passing through the detection resistor 31 and control the power control module 50 to function using the power supply controller IC 34. The processor 33 is also directly connected to the battery 11 for detecting the voltage of the battery 11. The power control module 50 can regulate the working power of the circuitry 70.

When the portable electronic device 200 is used, the battery 11 can supply electrical energy to the circuitry 70 through the power detection module 30 and the power control module 50. In other embodiments, the adapter 13 can be connected to another power supply (not shown). To regulate the voltage level of electrical energy provided by the other power supply connected thereto to a predetermined value and provide the electrical energy having a regulated voltage level to the circuitry 70 through the power detection module 30 and the power control module 50, a predetermined maximal power allowed to be used by the circuitry 70 is set and stored by the processor 33, and a predetermined value of the voltage of electrical energy provided by the adapter 13 is also stored in the processor 33.

When the PMU 100 supplies electrical energy to the circuitry 70, the processor 33 uses the power supply controller IC 34 to detect the current passing through the detection resistor 31, and thus calculates the power (i.e., watt value) of the electrical energy provided to the circuitry 70 according to the detected current. If the power of the electrical energy provided to the circuitry 70 exceeds the predetermined value, the PMU 100 can decrease the power of the electrical energy provided to the circuitry 70 to protect the circuitry 70 from over-current.

If the PMU 100 is supplying electrical energy to the circuitry 70 using another power supply connected to the adapter 13, the voltage of electrical energy provided by the adapter 13 is predetermined and invariable. Therefore, the processor 33 calculates the power of the electrical energy provided to the circuitry 70 according to the current passing through the detection resistor 31 and the predetermined voltage of electrical energy provided by the adapter 13. If the PMU 100 is supplying electrical energy to the circuitry 70 using the battery 11, the voltage of the battery 11 may often change. Therefore, during detecting the current passing through the detection resistor 31, the processor 33 synchronously detects the voltage of the battery 11, and thus calculates the power of the electrical energy provided to the circuitry 70 according to the current passing through the detection resistor 31 and the voltage of the battery 11.

When the calculated power of the electrical energy provided to the circuitry 70 exceeds the predetermined value, the processor 33 controls the power control module 50 to function using the power supply controller IC 34. The power control module 50 limits the power of the electrical energy provided to the circuitry 70 (e.g., by means of driving the circuitry 70 to work in a CPU thermal throttling status), thereby decreasing the working current provided to the circuitry 70 to protect the circuitry 70 from over-current.

When the adapter 13 is connected to another power supply, the adapter 13 can also provide electrical energy of the power supply to the battery 10 through the detection resistor 31, thereby recharging the battery 11. Therefore, the adapter 13 can be used as a charging interface of the portable electronic device 200. In the charging process, the processor 33 can detect the current charging the battery 10 by the detection resistor 31, and regulate the charging current or stop the charging process when the charging current or the voltage of the battery 10 exceeds predetermined values.

The present PMU 100 can detect the power provided to the circuitry 70 of the portable electronic device 200, and limit the power provided to the circuitry 70 when the power exceeds a predetermined value, such that the circuitry 70 is protected from over-current. It can also be used to charge the portable electronic device 200. Additionally, it has a simple structure and costs less.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A power management unit (PMU) for supplying electrical energy to a circuitry of a portable electronic device, comprising:
a power supply module;
a power detection module connected to the power supply module; and
a power control module connected to the power detection module and the circuitry; wherein the power supply module provides electrical energy to the circuitry through the power detection module and the power control module, and the power detection module detects the power of the electrical energy provided to the circuitry and controls the power control module to limit the power of the electrical energy provided to the circuitry when the power of the electrical energy provided to the circuitry exceeds a predetermined value.

2. The PMU as claimed in claim 1, wherein the power detection module includes a processor and a detection resistor connected to the processor, the processor connected to the power control module, the detection resistor connected to the power supply module, the processor detecting the current passing through the detection resistor.

3. The PMU as claimed in claim 2, wherein the processor includes a power supply controller integrated circuit (IC) connected to the resistor and the power control module, the power supply controller IC being a MAX8724 chip, the processor using the power supply controller IC to detect the current passing through the detection resistor and control the power control module.

4. The PMU as claimed in claim 2, wherein the power supply module includes a battery connected to the detection resistor and the processor for supplying electrical energy to the circuitry through the power detection module and the power control module, the processor detecting the voltage of the battery and calculates the power of the electrical energy provided to the circuitry according to the current passing through the detection resistor and the voltage of the battery.

5. The PMU as claimed in claim 4, wherein the power supply module further includes an adapter connected to the detection resistor, the adapter regulating the voltages of electrical energy provided by other power supplies connected thereto to a predetermined value and providing the electrical energy having the regulated voltage to the circuitry through the power detection module and the power control module, the processor calculating the power of the electrical energy provided to the circuitry according to the current passing through the detection resistor and the predetermined voltage of electrical energy provided by the adapter.

6. The PMU as claimed in claim 5, wherein the adapter provides electrical energy of other supplies connected thereto to the battery through the detection resistor to charge the battery.

7. The PMU as claimed in claim 6, wherein the processor detects the current charging the battery by the detection resistor, and regulates the charging current or stop the charging process when the charging current or the voltage of the battery exceeds predetermined values.
